(19) United States
(12) Patent Application Publication
(10) Pub. No.: US 2004/0118240 A1
(43) Pub. Date: Jun. 24, 2004

(54) Adaptive drive train cover

(76) Inventor: Douglas William Young, Sunnyvale, CA (US)

Correspondence Address: PATRICK REILLY, BOX 7218, SANTA CRUZ, CA, 95061-7218, US

(21) Appl. No.: 10/325,106

(22) Filed: Dec. 20, 2002

(51) Int. Cl. F16H 57/02

(52) U.S. Cl. 74/606 R

(57) ABSTRACT

A dual purpose outer primary housing, or cover, for a motorcycle drive train is provided. The cover has a lip, an ornamental design and a recess. The lip is shaped to form a seal with the inner primary housing. The recess is shaped to extend away from the lip and the inner primary housing when the two housings are operationally coupled. The recess is sized to accommodate a belt of up to a certain maximum width, for example a 3-inch wide toothed belt, and will therefor also accommodate a narrower metallic chain. The recess and the inner primary housing substantially form a pocket required to support the maintenance of the drive chain in an oil bath. When the motorcycle is modified to include a belt, the cover is modified by relieving material from the outer primary housing to form air path apertures that extend wholly through the cover.

### FIELD OF THE INVENTION

The field of the invention generally pertains to covers for motorcycle drive trains. The invention relates more particularly to an outer primary housing that can be removably attached to a motorcycle inner primary housing. A typical application of the present invention is to partially enclose a belt or drive chain of a HARLEY-DAVIDSON™ motorcycle.

### BACKGROUND OF THE INVENTION

An inner primary housing is commonly provided in motorcycle designs to attach an engine and a transmission to a frame and to position, and to maintain position, of the engine relative to the transmission. A drive train, to include the transmission and a drive chain or belt, translates the mechanical energy generated by the engine to a rear wheel. Several HARLEY-DAVIDSON™ motorcycle transmissions secure a final-drive transmission pulley or sprocket (belt or chain drive, respectively) to a main drive gear. The main drive gear has a cylindrically hollow center permitting a mainshaft to coaxially extend through and into the transmission case. When in operation, the mainshaft functions to transfer power into the transmission, while the main drive gear functions to transfer power to the rear wheel via a final-drive transmission pulley or sprocket.

A metallic drive chain will heat up significantly and is typically cooled by means of an oil bath. An outer primary housing is provided to, in combination with the outer primary housing, to provide a pocket to contain the oil bath. In contrast, a drive belt, such as a suitable toothed belt known in the art, is typically air-cooled and should be provided with a flow of air during operation. A drive belt is accommodated in the prior art by removing and discarding the outer primary housing. This discarding of the outer primary housing is often made necessary by the fact that many drive belts are wider than drive chains, and therefor can not be housed within the pocket formed by removably attaching the outer primary housing to the outer primary housing.

The outer primary housing may additionally serve the purpose of providing an opportunity to decorate or personalize a motorcycle by the addition of a visual signage, such as an emblem or an etched image. The prior art need to discard the outer primary housing when retrofitting a motorcycle by replacing the drive chain with a wider belt reduces the motorcycle owner's ability to make his or her motorcycle visually distinct, or to visually indicate an affinity with a particular group. The prior art need to include the outer primary housing only in motorcycles with drive chains reduces the owner's options to substantially present a uniform or shared visual appearance that appeals to a group identity, e.g., a riding club wherein club members desire to display a team emblem on their outer primary housings, when modifying the motorcycle from a chain based drive train to a belt based drive train.

There exists, therefor, a long felt need to provide an outer primary housing that can be removably attached to an inner primary housing and can alternatively support the protection of a drive chain or be modified to support the protection of a belt.

### BRIEF SUMMARY OF THE INVENTION

It is an object of the present invention to provide an adaptive outer primary housing, or adaptive drive train cover, that can be configured to partially protect either a drive chain or a drive belt. Towards this and other objects that will be made obvious in light of the present disclosure, a preferred embodiment of the present invention provides an outer primary housing having a lip, plurality of motorcycle attachment points, and a recess. The lip is shaped to form a seal with the inner primary housing when the inner and outer primary housings are mechanically coupled. The attachment points may optionally be a set of apertures that are positioned match a set of threaded receivers of the inner primary housing, whereby the inner and outer housings may be removably attached by extending individual elongate fasteners, e.g., threaded bolts, through each outer primary housing aperture and separately engaging a matching receiver. The recess is shaped to extend away from the lip and the inner primary housing when the two housings are operationally coupled. The recess is sized to accommodate a belt of up to a certain maximum width, for example a 3-inch wide toothed belt, and will therefor also accommodate a narrower metallic chain. In certain alternate preferred embodiments of the present invention, the recess is sized to accommodate a wide rear sprocket, the wide rear sprocket shaped to be driven by the belt having a certain maximum width, for example a 3 inch wide toothed belt. The recess and the inner primary housing substantially form the pocket required to support the maintenance of the drive chain in an oil bath. When the motorcycle is modified to include a belt of the predetermined width, or narrower than the predetermined width, the outer primary housing is modified by relieving material from the outer primary housing to form air path apertures that extend wholly through the outer primary housing. The outer primary housing so modified may is thereby be reattached to the inner primary assembly and permit the motorcycle to substantially maintain the same visual appearance of the motorcycle prior to the drive belt modification.

In certain alternate preferred embodiments of the present invention the outer primary housing presents an ornamental design. The ornamental design may optionally shaped to permit the formation of one or more air flow apertures with little or no marring of the appearance of the ornamental design.

In certain still alternate preferred embodiments of the present invention the outer primary housing may be or comprise a metal casting.

In certain yet alternate preferred embodiments of the present invention the outer primary housing may be or comprise a high temperature resistant plastic or carbon composite material, or other suitable material known in the art that can contain the oil bath about the drive chain during extended operation of the motorcycle.

In certain further alternate preferred embodiments, the method of the present invention provides a dual purpose adaptive cover, wherein the adaptive cover is configurable to either partially enclose (1) a relatively narrow chain, e.g. one inch in width, while for supporting a maintenance of the chain in a liquid bath, or (2) a relatively wide belt, e.g., three inches in width, while providing access by air for cooling the belt.

Other features of the present invention will be apparent from the accompanying drawings and from the detailed description, which follows.

### BRIEF DESCRIPTION OF THE DRAWINGS

The present invention is illustrated by way of example in the following drawings in which like references indicate similar elements. The following drawings disclose various embodiments of the present invention for purposes of illustration only and are not intended to limit the scope of the invention.

FIG. 1 is a perspective side view of a preferred embodiment of the present invention attached to a motorcycle and protecting a drive chain.

FIG. 2A is a partially cut-away top view of the preferred embodiment of the present invention of FIG. 1.

FIG. 2B is a top view of a prior art outer primary housing.

FIGS. 3A-3F are various perspective views of the preferred embodiment of the present invention of FIG. 1 configured and adapted to protect a drive belt.

FIG. 4 is an interior view of the preferred embodiment of the present invention of FIG. 1 and adapted to partially enclose a drive chain in a liquid coolant bath when attached to a motorcycle inner primary housing.

FIG. 5 is an exterior view of the preferred embodiment of the present invention of FIG. 1 adapted to protect a drive chain.

### DETAILED DESCRIPTION OF THE PREFERRED EMBODIMENTS

In describing the preferred embodiments, certain terminology will be utilized for the sake of clarity. Such terminology is intended to encompass the recited embodiment, as well as all technical equivalents, which operate in a similar manner for a similar purpose to achieve a similar result.

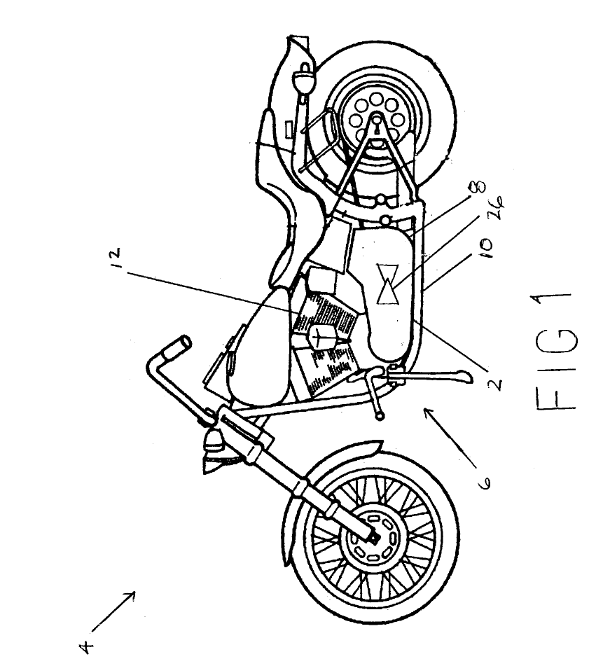

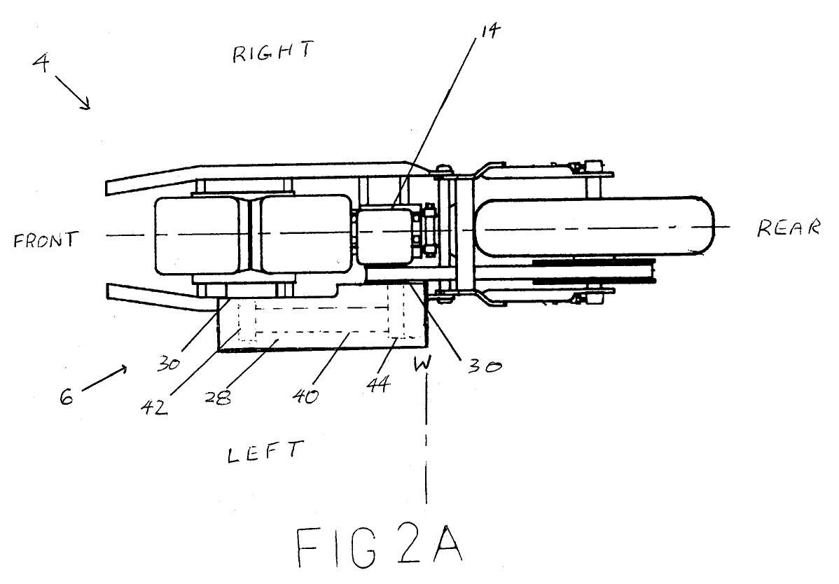

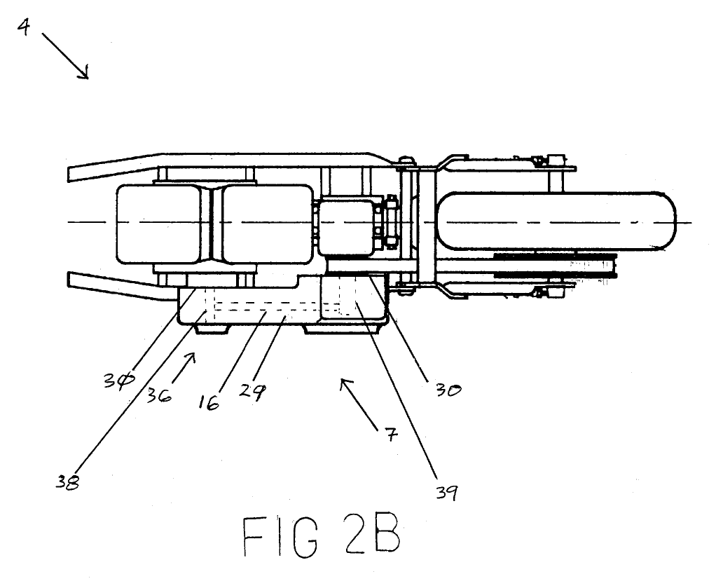

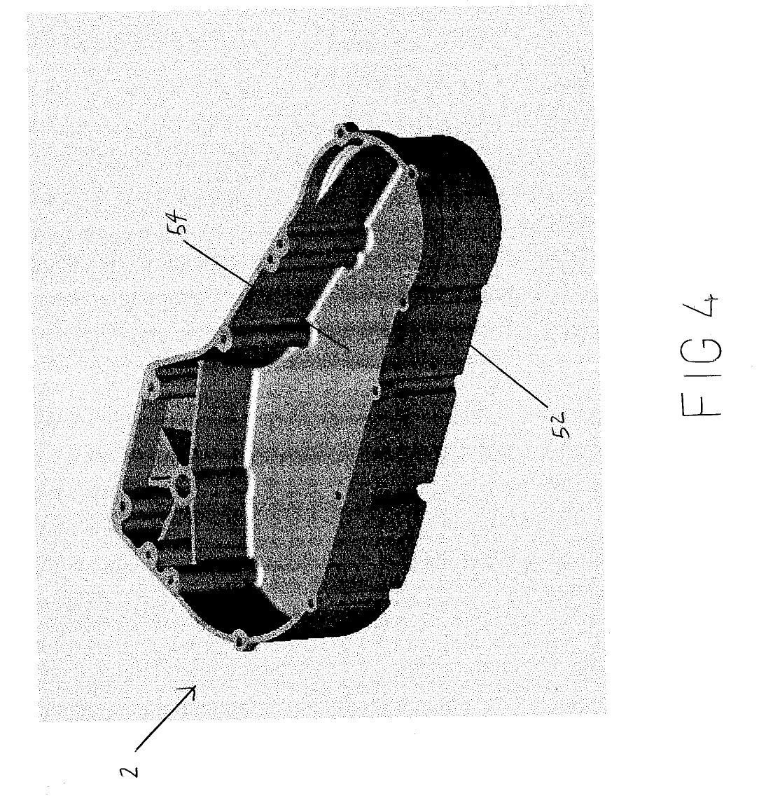

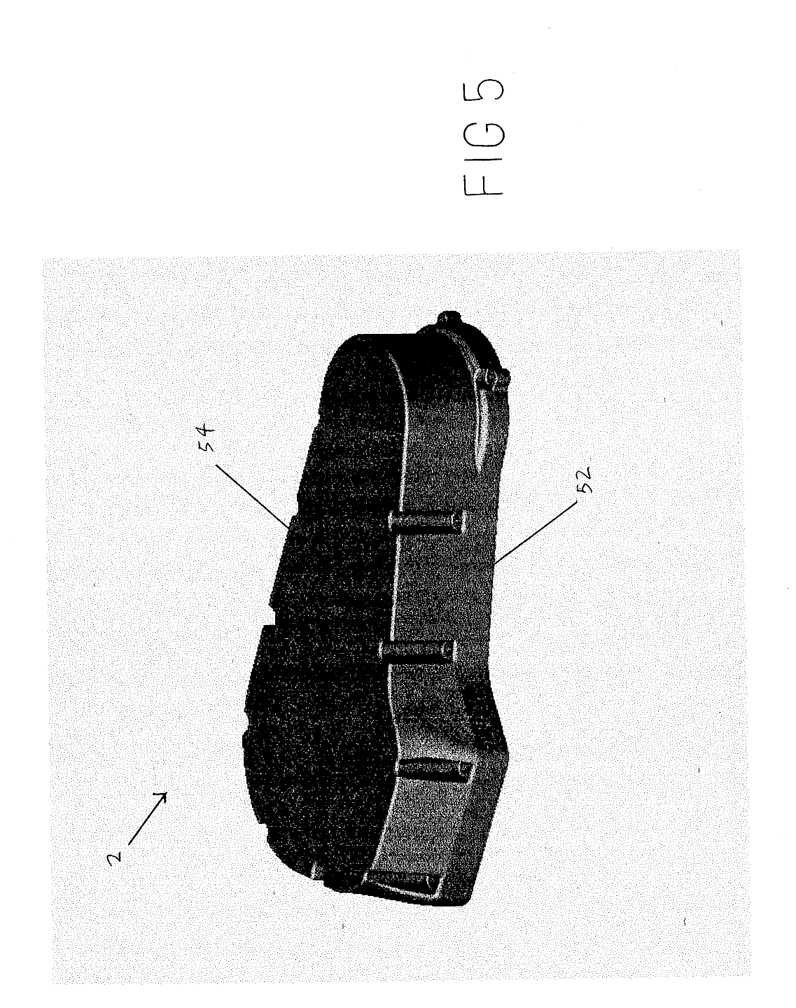

Referring now generally to the Figures and particularly to FIGS. 1 and 2A, FIG. 1 is a perspective side view of a preferred embodiment of the present invention 2, or cover 2, attached to a motorcycle 4 and protecting a drive train 6. The cover 2 may be adapted, as in the example of FIGS. 1, 2A and 3A through 3F to protect the drive train 6 having a relatively wide drive belt 40 (as shown in FIG. 2A). Alternatively, and as shown in FIGS. 4 and 5, the cover 2 may be adapted to protect a relatively narrow drive chain 16 of FIG. 2B of a drive train 7.

FIG. 2A is a partially cut-away top view of the cover 2 of FIG. 1. As per FIGS. 1 and 2A, an inner primary housing 8 is attached to a frame 10 of the motorcycle 4 and the inner primary housing 8 secures the position of an engine 12 relative to a transmission 14 and the frame 10. The drive train 6 includes the transmission 14 and the drive belt 40. The drive belt 40 circulates about a front sprocket 42 and a rear sprocket 44.

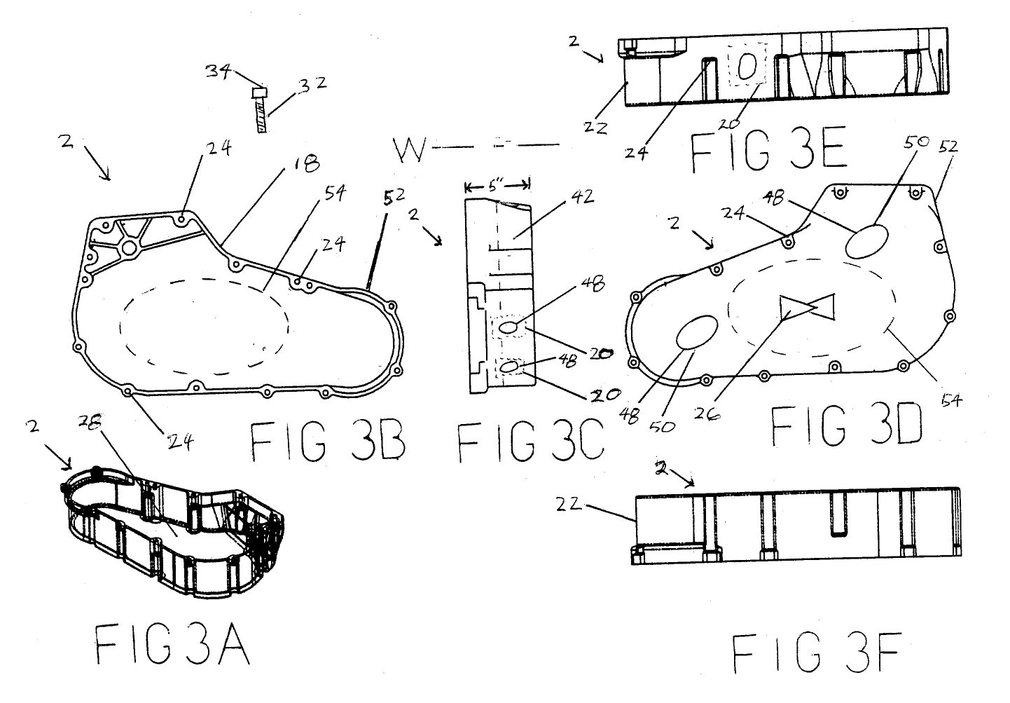

Referring now generally to the drawings, and particularly to FIGS. 3A through 3F, the cover 2 has a lip 18, a plurality of relievable zones 20, a recess 22, a plurality of cover attachment apertures 24, and an ornamental design 26. The lip 18 runs substantively along a periphery of the cover 2 and forms a seal against the inner primary housing 8, thereby forming a pocket 28 for that may hold an oil bath 29 when the cover 2 is adapted for use with the drive chain 16 rather than the drive belt 40. The cover attachment apertures 24 are located on the cover to match a pattern of inner primary housing receivers 30 of the inner primary housing 8. The receivers 30 are each threaded and sized to accept a separate threaded bolt 32. Each threaded bolt 32 extends through one cover aperture 24 and mechanically couples with one receiver 30. During operation of the motorcycle 4, a head of the bolt 34 presses the cover 2 against the inner primary housing 8. In certain alternate preferred embodiments of the present invention a suitable elongate fastener, or other suitable fasteners or fasteners assemblies known in the art are used attach the cover 2 to the motorcycle 4. The bolt heads 34 are positioned distal from the seating receivers 30 associated with each bolt 32 when the cover 2 is operationally attached to the inner primary housing 8. The cover 2 may be detached from the inner primary housing 8 by rotating the bolts 32 to uncouple the bolts 32 and the inner primary housing 8. The ornamental design 26 is oriented to provide of view of the ornamental design 26 to an observer standing away from, or distally from, the motorcycle 4.

FIG. 2B is a top view of a prior art outer primary housing 36. The prior art outer primary housing 36 encloses the relatively narrow one-inch wide drive chain 16. FIG. 2A, in contrast to FIG. 2B, presents the one inch wide drive chain 16, front sprocket 38, and rear sprocket 39 of the prior art example as replaced with a relatively wider three inch wide drive belt 40, a wider front sprocket 42 and a wider rear sprocket 44. The sprockets of FIG. 2A are sized and cooperate with the drive belt 40. The belt 40 is approximately three inches in width.

Referring now generally to the Figures and particularly to FIGS. 3A through 3F, FIG. 3A is a perspective view of the cover 2 of FIG. 1 adapted to protect a drive belt 40. The cover 2 is approximately 5 inches in width, along axis W as shown in FIG. 3C. In certain still alternate preferred embodiments of the present invention an insert 46 may be added to the cover 2. The insert 46 fills up a volume of the cover 2 and thereby reduces the size of the oil bath 29 within the pocket 29. The inset 42 is sized and shaped to not interfere with the operation of the drive chain 16. The lip 18 of the cover 2 continues to form a seal against the inner primary housing 8 by means of the plurality of receiver-bolt-cover aperture combinations. At least one relievable zone 20 has been removed to form an airflow aperture 48. The recess 22 is sized and shaped to permit the unimpeded operation of the drive belt 40 in combination with the wider front sprocket 42 and the wider rear sprocket 44. Airflow apertures 48 may also be placed at alternate locations 50 of the cover 2 in certain alternate preferred embodiments of the cover 2. FIG. 3B is a view of the cover 2 as viewed from the right side of the motorcycle 4 when the cover 2 is attached to the motorcycle 4. FIG. 3C is a front view of the cover 2 as viewed from the front of the motorcycle 4 when the cover 2 is attached to the motorcycle 4. FIG. 3D is a side view of the cover 2 as viewed from the left side of the motorcycle 4 when the cover 2 is attached to the motorcycle 4. FIG. 3E is a top view of the cover 2 as viewed from above the motorcycle 4 when the cover 2 is attached to the motorcycle 4. FIG. 3F is a bottom view of the cover 2 as viewed from beneath the motorcycle 4 when the cover 2 is attached to the motorcycle 4.

Referring now generally to the Figures and particularly to FIG. 4 and FIGS. 3C, 3D and 3E, FIG. 4 is an interior view of the cover 2 of FIG. 1. The interior of cover 2 is defined herein as a side of the cover 2 that is closer to a belt 40 or chain 16 when the cover 2 is installed on the motorcycle 4. In certain alternate preferred embodiments of the present invention the cover 2 may be or comprise a high temperature resistant plastic or carbon composite material, or other suitable material known in the art that can contain the oil bath about the drive chain during extended operation of the motorcycle. As one example, the cover 2 may be or comprise metal casting, such as a combination casting. A first section 52 of the cover 2 may be formed with a main mold, and a second section 54 of the cover 2, wherein the second section 54 comprises the ornamental design 26, may be a formed with a design specific mold. The fabricator of the cover 2 may have a family of design specific molds, whereby a variety of covers 2 may be cast, each cover 2 having a unique design corresponding to an individual design specific mold. This alternate preferred embodiment of the method present invention further allows design specific molds to be used in combination with alternate main molds, wherein individual alternate main molds are shaped to conform with the operation requirements of specific alternate inner primary housing designs. The method of the present invention may thereby enable a reduced cost casting of a variety of ornamental designs comprised within covers 2 shaped for one of a variety of motorcycle makes and models.

Referring now generally to the Figures and particularly to FIG. 5, FIG. 5 is an exterior view of the cover 2 of FIG. 1 as adapted to protect the drive chain 16. Exterior is defined herein as a side of the cover 2 that is further from the belt 40 or the chain 16 when the cover 2 is installed on the motorcycle 4.

From the above description and drawings, it will be understood by those of ordinary skill in the art that the particular embodiments shown and described are for purposes of illustration only and are not intended to limit the scope of the invention. Those of ordinary skill in the art will recognize that the invention may be embodied in other specific forms without departing from its spirit or essential characteristics. References to details of particular embodiments are not intended to limit the scope of the claims. The present embodiments of this invention are thus to be considered in all respects as illustrative and not restrictive; the scope of the invention being indicated by the appended claims rather than by the foregoing description. All changes which come within the meaning and range of equivalency of the claims are intended to be embraced therein.

I claim:

1. A cover for a segment of a drive train of a motorcycle, the motorcycle comprising an inner primary housing, the cover comprising:
at least one relievable zone and a recess;
the cover shaped to, in combination with the inner primary housing, maintain the segment of the drive chain of the motorcycle in a liquid coolant bath when the cover is attached to the motorcycle inner primary housing;
the recess shaped to permit a belt to function in replacement of the drive chain; and
the relievable zone located on the cover to permit the establishment of at least one aperture, the aperture extending through the cover, whereby the aperture would permit air cooling of the belt.

2. The cover of claim 2, wherein the inner primary housing includes a plurality of motorcycle attachment points arranged about the segment of the drive train, the cover further comprising:
at least two cover attachment points; and
each of the at least two cover attachment points positioned to each align with at least one of the plurality of motorcycle attachment points of the inner primary housing.

3. The cover of claim 2, wherein at least one of the motorcycle attachment points includes a seating aperture, the cover further comprising:
at least one elongate fastener, the elongate fastener shaped and sized to mechanically couple with the seating aperture of the motorcycle; and
at least one cover attachment point comprising an attachment aperture, the attachment aperture extending through the cover and oriented to permit the elongate fastener to extend through the cover and for the elongate fastener to mechanically couple with the seating aperture.

4. The cover of claim 3, wherein the motorcycle seating aperture is tapped to receive a threaded bolt, and the elongate fastener of the cover is a threaded bolt, whereby the cover is detachably attachable to the motorcycle inner primary housing by means of the elongate fastener.

5. The cover of claim 4, wherein the motorcycle has a plurality of seating apertures, and each seating aperture is tapped to receive a threaded bolt, and the cover further comprises a plurality of elongate fasteners, and at least two of the plurality of elongate fasteners are threaded bolts sized and shaped to mechanically couple with at least one seating aperture, and at least two cover attachment points include cover apertures, each of the at least two cover apertures extending through the cover and oriented to permit at least one threaded bolt to extend through the cover and mechanically couple with one of the plurality of motorcycle seating apertures, whereby the cover is detachably attachable to the motorcycle inner primary housing by means of the threaded bolts and the tapped seating apertures.

6. The cover of claim 1, wherein the motorcycle comprises a belt functioning in place of the drive chain, and the cover further comprises at least one aperture extending through the relievable zone, whereby the at least one aperture enables air-cooling of the belt.

7. The cover of claim 1, wherein the motorcycle comprises a belt functioning in place of the drive chain, and the cover further comprises a plurality of apertures extending through the relievable zone, whereby the plurality of apertures enables air cooling of the belt.

8. The cover of claim 1, wherein the cover further comprises a plurality of relievable zones.

9. The cover of claim 1, wherein the motorcycle comprises a belt functioning in place of the drive chain, and the cover further comprises a plurality of apertures, whereby the plurality of apertures permit air-cooling of the belt.

10. The cover of claim 1, wherein the cover is a metal casting.

11. The cover of claim 10, wherein the metal casting is a combination casting of at least two parts.

12. The cover of claim 1, wherein the cover comprises a material selected from the group consisting of plastic, composite, and high carbon composite.

13. The cover of claim 1, wherein the cover comprises an ornamental design, the ornamental design visible on a side of the cover distal from the motorcycle when the cover is attached to the motorcycle.

14. The cover of claim 13, wherein the cover comprises a metal casting.

15. The cover of claim 14, wherein the motorcycle comprises a belt functioning in place of the drive chain, and the metal casting further comprises a plurality of apertures, whereby the plurality of apertures permit air cooling of the belt.

16. The cover of claim 14, wherein the metal casting comprises a combination casting, and a first part of the combination casting is removably attached to the motorcycle and the ornamental design is located on a second part of the combination casting.

17. The cover of claim 13, wherein the cover comprises a material selected from the group consisting of plastic, composite, and high carbon composite.

18. The cover of claim 17, wherein the plastic material comprises a combination molding, and a first part of the combination molding is removably attached to the motorcycle and the ornamental design is located on a second part of the combination molding.

19. A dual purpose adaptive cover, the cover configured to partially enclose a drive train of a motorcycle, and the cover adapted to partially enclose one of:
a relatively narrow chain, and for maintaining the chain in a liquid bath; and
a relatively wide belt, and providing access by air for cooling the belt.
